(19) United States
(12) Patent Application Publication
(10) Pub. No.: US 2006/0120312 A1
(43) Pub. Date: Jun. 8, 2006

(54) Communications method, communications system, relay apparatus, and recording medium

(75) Inventors: Hitoshi Yamauchi, Kawasaki (JP); Ryuichi Matsukura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/117,550

(22) Filed: Apr. 29, 2005

(30) Foreign Application Priority Data
Dec. 8, 2004 (JP) 2004-356013

(51) Int. Cl. H04B 7/00

(52) U.S. Cl. 370/310

(57) ABSTRACT

There are provided a communications method, a communications system, a relay apparatus, and a computer program in which the communication remains stable between a terminal unit such as a mobile IP telephone and the relay apparatus used as an access point in the streaming communication service such as IP telephone in a wireless LAN environment when the condition of communication is unfavorable. The relay apparatus (1) is arranged to, when a desired amount of data for the streaming service is transmitted to each of the terminal units (2) over a communication bandwidth assigned to the terminal unit (2) at a communication speed predetermined for the terminal unit (2), modify the communication speed to the lowest rate.

### CROSS-REFERENCE TO RELATED APPLICATIONS

This Nonprovisional application claims priority under 35 U.S.C. §119(a) on Patent Application No. 2004-356013 filed in Japan on Dec. 8, 2004, the entire contents of which are hereby incorporated by reference.

### BACKGROUND OF THE INVENTION

The present invention relates to a communications method including a group of terminal units and a relay apparatus for conducting wireless communications with the terminal units, a communications system employing the communications method, a relay apparatus used in the communications system, and a computer program embodying the relay apparatus. Particularly, the present invention relates to a communications method, a communications system, a relay apparatus, and a recording medium where the quality of communications can hardly be declined.

In recent years, IP telephones using the VoIP (voice over IP) technique have spread rapidly in homes and offices. Most recently, mobile IP telephones over wireless LAN have begun to receive attention, and they are now introduced into a part of companies.

In a communications system using a radio communications technique such as a wireless LAN, two or more terminal units provided in the service area of each relay apparatus called an access point receive the same signal. For avoiding any collision in communications between the terminal units, the relay apparatus employs a technology of CSMA/CA (carrier sense multiple access with collision avoidance) where the terminal units can communicate with each other over a commonly assigned range of the communication bandwidth.

Such a wireless LAN includes a fall-back communication function such as communication frame retransmission or link-speed optimization for sustaining the communication while maintaining the quality of the communication even when the communication is disturbed by any interference on the route of the communication or an increasing distance between the relay apparatus and the terminal unit or between the two terminal units. The communication frame retransmission is a function for acknowledging the transmission of communication frames through examining the receipt of an ACK (acknowledgment) frame at the MAC (media access control) layer and upon finding that the ACK frame has not been received, re-transmitting the communication frames. The link-speed optimization is a function for, when the receipt of the communication frames is not confirmed after the transmission of the communication frames, repeating the retransmission of the communication frames until the ACK frame is received and lowering at steps the link speed or data transmission speed between the relay apparatus and the corresponding terminal unit. In the IEEE 802.11b based wireless communications system at, for example, the link speed is declined initially from 11 Mbps to 5.5 Mbps and then to 2 Mbps and 1 Mbps. When the communication returns back to its favorable condition, the link speed is increased to improve the throughput as a whole.

When the condition of communication is declined, the function of communication frame retransmission repeats the transmission of communication frames thus creating a delay. In addition, the transmission of communication frames will be repeated until the link speed drops down from a high rate to a low rate ensuring the stable communication due to the function of optimizing the link speed, thus generating a delay. When the retransmission of communication frames fails to communicate with the target terminal unit, the communication frames are discarded thus creating undesired packet loss. Moreover, the function of optimizing the link speed permits the link speed to be increased when the condition of communication returns back to its favorable level. As the condition of communication is varied, the link speed will change up and down repeatedly thus requiring the retransmission of communication frames and producing a delay. In known FTP (file transfer protocol) or HTTP (hyper text transfer protocol) communication technology, such delay or packet loss may be negligible. However, they will cause unwanted deterioration in the quality of audio or video signals in the streaming communication service such as VoIP telephone system.

When the link speed drops down, the relay apparatus increases the rate of occupying the communication bandwidth to be assigned to the terminal unit in order to maintain the amount of data to be transmitted per unit time for the streaming service. For example, if the line speed drops from 11 Mbps to 5.5 Mbps, the communication bandwidth assigned to the terminal unit has to be doubled for transferring the predetermined amount of data.

For overcoming the above described drawback, a communications method is introduced as disclosed in Japanese Patent Laid-open Publication 2003-244105, in which the cycle of changing the link speed is varied at each setting of the link speed thus to improve the efficiency of optimizing the link speed. For varying different rates of the link speed at equal cycles, the cycle has to be increased to match with the lowest of the link speed which takes more time for transmitting the communication frames. Accordingly, the cycle of changing the link speed is varied at each setting of the link speed. More specifically, when the link speed is high enough to transmit the communication frames within a short time but susceptible to the condition of communication such as a state of communication waves, it can be modified at cycles of a short period. When the link speed is low enough to take a considerable length of time for transmitting the communication frames but less susceptible to the condition of communication, it can be modified at cycles of a long period. The communications method disclosed in Japanese Patent Application Laid-open 2003-244105 may allow the link speed to be increased at higher efficiency under the environment where the condition of communication remains less varied and the link speed is rather stable, thus improving the throughput as a whole.

### BRIEF SUMMARY OF THE INVENTION

The present invention has been developed in view of the above aspects and its object is to provide a communications method for determining the link speed depending on the occupied state of the communication bandwidth thus to attenuate the effect of the condition of communication, minimize a change in the link speed, and prevent the transmission of communication frames from being repeated, a communication system employing the communications method, a relay apparatus used in the communication system, and a recording medium in which a computer program for embodying the relay apparatus is stored.

As a first feature of the present invention, a communications method is provided using a group of terminal units and a relay apparatus for conducting wireless communications with the terminal units. The relay apparatus is arranged to assign each terminal unit with an available range of the communication bandwidth which is not occupied and send/receive data with the terminal unit over the available range of the communication bandwidth at a communication speed predetermined for the terminal unit. In particular, the method allows the relay apparatus to modify the communication speed of the terminal unit in response to the occupied state of the communication bandwidth.

As a second feature of the present invention, a communications system is provided using a group of terminal units and a relay apparatus for conducting wireless communications with the terminal units. The relay apparatus is arranged to assign each terminal unit with an available range of the communication bandwidth which is not occupied and send/receive data with the terminal unit over the available range of the communication bandwidth at a communication speed predetermined for the terminal unit. In particular, the relay apparatus in the system include means for modifying the communication speed of the terminal unit in response to the occupied state of the communication bandwidth.

As a third feature of the present invention, a relay apparatus is provided having means for conducting wireless communications with a group of terminal units and means for assigning each of the terminal units with an available range of the communication bandwidth which is not occupied and sending/receiving data with the terminal unit over the available range of the communication bandwidth at a communication speed predetermined for the terminal unit. In particular, the relay apparatus comprises means for recording the occupied state of the communication bandwidth and means for modifying the communication speed of the terminal unit in response to the recorded occupied state of the communication bandwidth.

As a forth feature of the present invention, a relay apparatus is provided having means for conducting wireless communications with a group of terminal units and means for assigning each of the terminal units with an available range of the communication bandwidth which is not occupied and sending/receiving data with the terminal unit over the available range of the communication bandwidth at a communication speed predetermined for the terminal unit. In particular, the relay apparatus comprises means for recording the occupied state of the communication bandwidth, means for calculating a favorable range of the communication bandwidth from the occupied state of the communication bandwidth, and means for modifying the communication speed of the terminal unit to as a low rate as possible at the available range of the communication bandwidth.

As a fifth feature of the present invention, the relay apparatus defined by the third or fourth feature of the present invention further comprises means for detecting a change in the number of the terminal units being connected or a change in the condition of communication at the terminal unit and means for modifying the communication speed of each of the terminal unit or assigning again the terminal unit with a favorable range of the communication bandwidth in response to the change.

As a sixth feature of the present invention, the relay apparatus defined by any of the third to fifth features of the present invention further comprises means for receiving a demand for starting a communication from one of the terminal units which is not connected, wherein the means for modifying the communication speed for communication with the one of the terminal units which demands the start of communication.

As a seventh feature of the present invention, the relay apparatus defined by the sixth feature of the present invention further comprises means for examining from the available range of the communication bandwidth determined by the calculating means whether a desired range of the communication bandwidth is available or not for communication with the one of the terminal units which demands the start of communication, means for, when it is judged that the desired range of the communication bandwidth is not available, detecting the condition of communication with the terminal units being connected, means for selecting the terminal unit of which the communication speed is to be increased through reviewing the detected condition of communication, and means for increasing the communication speed of the selected terminal unit.

As an eighth feature of the present invention, the relay apparatus defined by any of the third to seventh features of the present invention further comprises means for measuring a declination in the condition of communication at the terminal unit being connected, means for detecting the condition of communication with the other terminal units, means for selecting the terminal unit of which the communication speed is to be increased through reviewing the detected condition of communication, means for increasing the communication speed of the selected terminal unit, means for assigning again the terminal unit of which the condition of communication is declined with a favorable range of the communication bandwidth, and means for decreasing the communication speed of the terminal unit of which the condition of communication is declined.

As a ninth feature of the present invention, the relay apparatus defined by any of the third to eighth features of the present invention is modified in which the data sent and received with the terminal units is data for the streaming service which has to be transmitted at a predetermined speed.

As a tenth feature of the present invention, a computer program is provided allowing a computer, which includes means for conducting wireless communications with a group of terminal units, to assign each of the terminal units with an available range of the communication bandwidth which is not occupied and send/receive data with the terminal unit over the available range of the communication bandwidth at a communication speed predetermined for the terminal unit. In particular, the computer program allows the computer to carry out a step of modifying the communication speed of the terminal unit in response to the occupied state of the communication bandwidth.

According to the present invention, the communication speed is determined depending on the occupied state of the communication bandwidth or particularly the communication speed is modified to as a low rate as possible which is less susceptible to the condition of communication such as a state of communication wave, thus ensuring the stableness of the communication. Also, since the cycle of modifying the communication speed is minimized, the number of times for transmitting the communication frames at the change of the communication speed can be decreased, thus eliminating any delay derived from the retransmission of the communication frames. Moreover, as the communication bandwidth is effectively assigned, its shortage can be avoided during the communications.

According to the present invention, when the number of the terminal units connected to the relay apparatus is changed, e.g., another terminal unit being disconnected demands to start a communication and the communication bandwidth is not available for the another terminal unit starting a communication, the communication speed of the terminal unit of which the condition of communication is higher is hastened thus to produce a spare range of the communication bandwidth assigned to the another terminal unit which demands to start a communication. This allows a more number of the terminal units to be connected for conducting the communications. Also, as the communication speed of the terminal unit of which the condition of communication is higher is hastened, any declination in the condition of communication of the terminal unit caused by increasing the communication speed can be minimized thus permitting the retransmission of communication frames to be carried out at less frequency for modifying the communication speed. As a result, any delay derived from repeating of the transmission of communication frames will be minimized.

According to the present invention, when the condition of communication is declined, e.g., a caller operating the terminal unit moves into a low communication signal area during the conversation, it can be returned back to a stable level by increasing the communication speed of the other terminal unit of which the condition of communication is higher to create a spare range of the communication bandwidth while decreasing the communication speed of the terminal unit of the caller thus to widen the assigned range of the communication bandwidth. Also, as the other terminal unit of which the condition of communication is higher is increased in the communication speed to produce a spare range of the communication bandwidth, its condition of communication can hardly be turned unstable. This permits the retransmission of communication frames to be carried out at less frequency for modifying the communication speed. As a result, any delay derived from repeating of the transmission of communication frames will be minimized.

In the communications method, the communications system, the relay apparatus, or the recording medium according to present invention, using the relay apparatus as an access point for a group of the terminal units such as mobile IP telephones which are connected by wireless communication to the relay apparatus, both the available range of the communication bandwidth assigned to each of the terminal units and the communication speed of the terminal unit over the available range of the communication bandwidth are favorably determined by the relay apparatus. Particularly, the communication speed can be modified to as a low rate as possible.

This permits the communication speed to stay low and thus be less susceptible to the effect of the condition of communication such as a state of communication wave, thus producing an advantageous effect such as stableness of the communications. Also, the communication speed needs not to be increased when the condition of communication remains stable and the frequency of modifying the communication speed can be decreased. Accordingly, the number of times for transmitting the communication frames at the change of the communication speed can be minimized. This will produce another advantageous effect such as elimination of any delay derived from the retransmission of the communication frames. In addition, since the communication bandwidth is assigned at higher efficiency, it can be minimized in the shortage of the communication bandwidth during the communication thus giving an further advantageous effect. Moreover, a minimum of the packet loss caused by repeating the transmission of communication frames will be encountered hence preventing the quality of audio signal from declining and giving an advantageous effect.

According to the present invention, when a change in the number of the terminal units connected to the relay apparatus is found, e.g., another terminal unit demands to start a communication and an available range of the communication bandwidth assigned to the another terminal unit is not available, the communication speed of the terminal unit of which the condition of communication is higher is hastened to produce a spare range of the communication bandwidth which is thus assigned to the another terminal unit. This allows a more number of the terminal units to be connected for communication. Also, the terminal unit of which the condition of communication is higher is increased in the communication speed to create a spare range of the communication bandwidth, any declination in the condition of communication of the terminal unit caused by increasing the communication speed can be minimized thus permitting the retransmission of communication frames to be carried out at less frequency for modifying the communication speed. Consequently as a further advantageous effect, any delay derived from repeating of the transmission of communication frames will be minimized.

According to the present invention, when the condition of communication is declined, e.g., a caller operating the terminal unit moves into a low communication signal area during the conversation, it can be returned back to a stable level by increasing the communication speed of the other terminal unit of which the condition of communication is higher to create a spare range of the communication bandwidth while decreasing the communication speed of the terminal unit of the caller thus to widen the assigned range of the communication bandwidth. Also, as the other terminal unit of which the condition of communication is higher is increased in the communication speed to produce a spare range of the communication bandwidth, its condition of communication can hardly be turned unstable. This permits the retransmission of communication frames to be carried out at less frequency for modifying the communication speed. As a result, any delay derived from repeating of the transmission of communication frames will be minimized.

The above and further objects and features of the invention will more fully be apparent from the following detailed description with accompanying drawings.

### BRIEF DESCRIPTION OF THE SEVERAL VIEWS OF THE DRAWINGS

FIG. 1 is an explanatory view schematically showing an arrangement of a communications system of the present invention;

FIG. 2 is a block diagram showing an arrangement of components in the communications system of the present invention;

FIG. 3 is an explanatory view schematically showing an example of management table stored in a relay apparatus of the present invention;

FIGS. 4A and 4B are flowcharts showing a procedure of starting a new communication at the relay apparatus in the communications system of the present invention;

FIGS. 5A and 5B are flowcharts showing a procedure of improving the condition of communication at the relay apparatus in the communications system of the present invention; and

FIG. 6 is a flowchart showing a procedure of slowing down the communication speed at the relay apparatus in the communications system of the present invention.

### DETAILED DESCRIPTION OF THE INVENTION

As described above, the conventional communications method disclosed in Japanese Patent Laid-open Publication 2003-244105 may hardly sustain the communication quality when the condition of communication is changed abruptly or remains unstable. In case that a terminal unit is moved from the communication easy area to the communication difficult area, its communication quality will sharply decrease. It is assumed for compensation that the link speed has thus to be shifted from 11 Mbps to 1 Mbps. As the conventional method repeats the transmission of communication frames for decreasing the link speed by steps, it will generate a delay. Also, when the link speed is varied up and down in any unstable condition of the communication, the transmission of communication frames is repeated thus creating a delay.

The present invention has been developed in view of the foregoing aspects and its object is to provide a communications method for determining the link speed in response to the use of communication bandwidths thus to minimize the effect of the condition of the communication and decrease a change in the link speed so that the retransmission of communication frames can be avoided, a communications system employing the communications method, a relay apparatus used in the communications system, and a recording medium on which a computer program for embodying the relay apparatus is stored. They will be realized by the following embodiments.

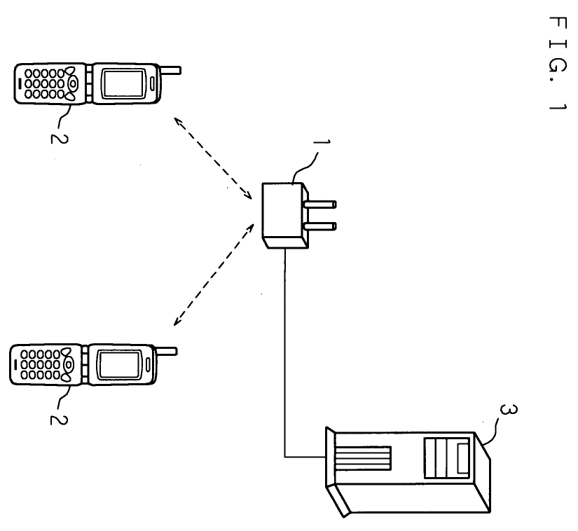

The preferred embodiments of the present invention will be described in more detail referring to the relevant drawings. FIG. 1 is an explanatory view schematically showing an arrangement of the communications system of the present invention. Denoted by 1 in FIG. 1 is a relay apparatus of the present invention provided as an access point with a communication computer for transferring radio communications. The relay apparatus 1 allows a group of terminal units 2, such as IP mobile telephones, to perform radio communications with each other over an available system such as CSMA/CA. The relay apparatus 1 is connected to a communication management center 3 provided with a stream server computer for controlling the communications between the terminal units 2 with the use of an applicable format such as SIP (session initiation protocol). The communications management center 3 identifies each communication to be controlled from its identifier.

The communications management center 3 develops a wireless LAN between the relay apparatus 1 and the terminal units 2 and can thus allow the relay apparatus 1 to provide the terminal units 2 over the wireless LAN with a streaming service such as VoIP service based on the QoS (quality of service) technology determined by IEEE 802.11e.

In such a conventional wireless LAN, the communication bandwidth is shared by a group of the terminal units 2. Accordingly, the streaming service such as VoIP service is carried out through giving priority to transferring the communication frames controlled by the communications management center 3. Also, the communication bandwidth is dynamically assigned to each of the terminal units 2 by the relay apparatus 1. Moreover, the communication speed (the link speed) assigned to each of the terminal units 2 can dynamically be determined by the relay apparatus 1. The wider the communication bandwidth assigned to the terminal unit 2 by the relay apparatus 1 or the higher the communication speed, the greater the amount of data to be transferred can be increased. However, when the condition of the communication such as the transmission of waves is low, the communication quality at higher speeds will remain high with much difficulty.

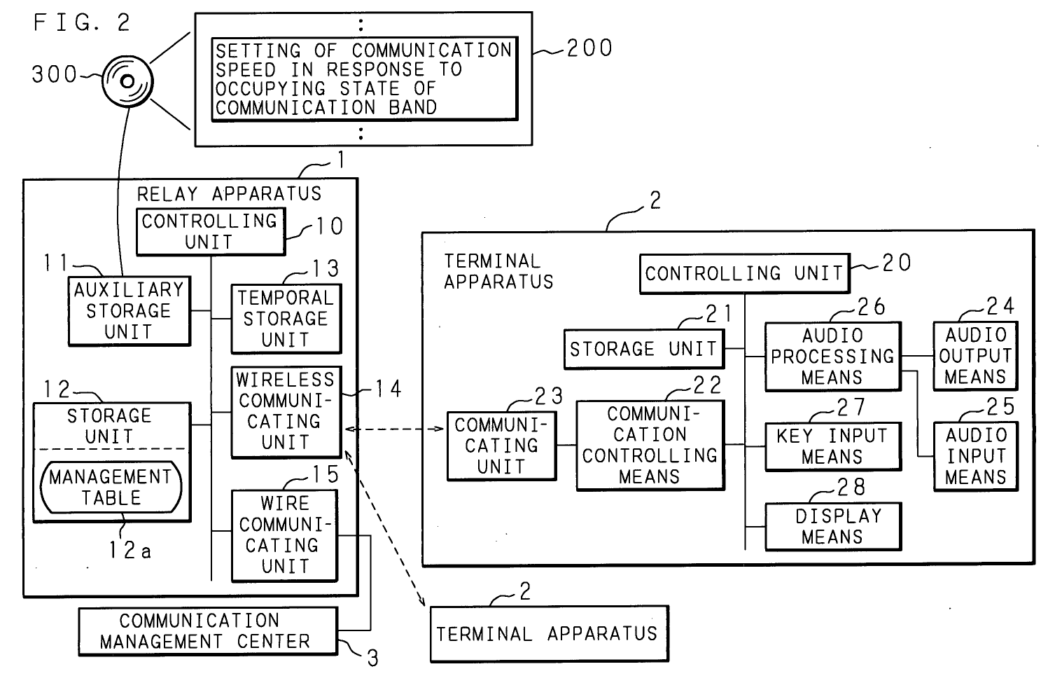

FIG. 2 is a block diagram showing an arrangement of components in the communications system of the present invention. The relay apparatus 1 comprises a controlling unit 10, such as a CPU, for controlling the entire action of the apparatus, an auxiliary storage unit 11, such as a CD-ROM drive, for reading from a recording medium 300, such as a CD-ROM, a variety of data including a computer program 200 of the present invention, a storage unit 12, such as a hard disk drive, provided in which the data read from the auxiliary storage unit 11 are saved, and a temporal storage unit 13, such as a RAM, for temporarily storing the data. A variety of data including the computer program 200 of the present invention are picked up from the storage unit 12 and saved in the temporal storage unit 13 such as a RAM before used. The computer program 200 is received by the controlling unit 10 where its contained procedures are executed for operating the communication computer as a function of the relay apparatus 1. The relay apparatus 1 also includes a wireless communicating unit 14 for carrying out radio communications with the terminal units 2 and a wire communicating unit 15 for carrying out wire communications with the communications management center 3. The storage unit 12 in the relay apparatus 1 has a storage region thereof provided as a management table 12a for controllably determining communication specific data including the communication speed and the communication bandwidths to be used for communication with the terminal units 2. The management table 12a is not limited to the storage region of the storage unit 12 in the relay apparatus 1 but may be implemented by a storage region of a storage unit in any other apparatus which is connected to the relay apparatus 1.

The terminal unit 2 comprises a controlling unit 20 for controlling the entire action of the terminal unit and a storage unit 21, such as a ROM or RAM, for storing a variety of data including computer programs and their relevant data used for carrying out desired processing actions. The controlling unit 20 is also arranged to control the action of a communication controlling unit 22 for controlling communications which in turn controls the action of a communicating unit 23 consisting mainly of an antenna and its relevant circuit for transmitting and receiving digital signals of the data for telephone communications. The controlling unit 20 further controls the action of an audio processing unit 26 for processing analog audio signals to be released from an audio outputting unit 24 such as a loudspeaker(s) and analog audio signals received from an audio inputting unit 25 such as a microphone. The processing action of the audio processing unit 26 involves converting a digital audio signal into the analog audio signal to be released from the audio outputting unit 24 and the analog audio signal received from the audio inputting unit 25 into a digital audio signal. The terminal unit 2 further includes a key inputting unit 27 for inputting commands and alphanumeric data through key entry under the controlling action of the controlling unit 20 and a displaying unit 28, such as a liquid crystal display, for displaying the key entry data or any other desired data received or to be transmitted.

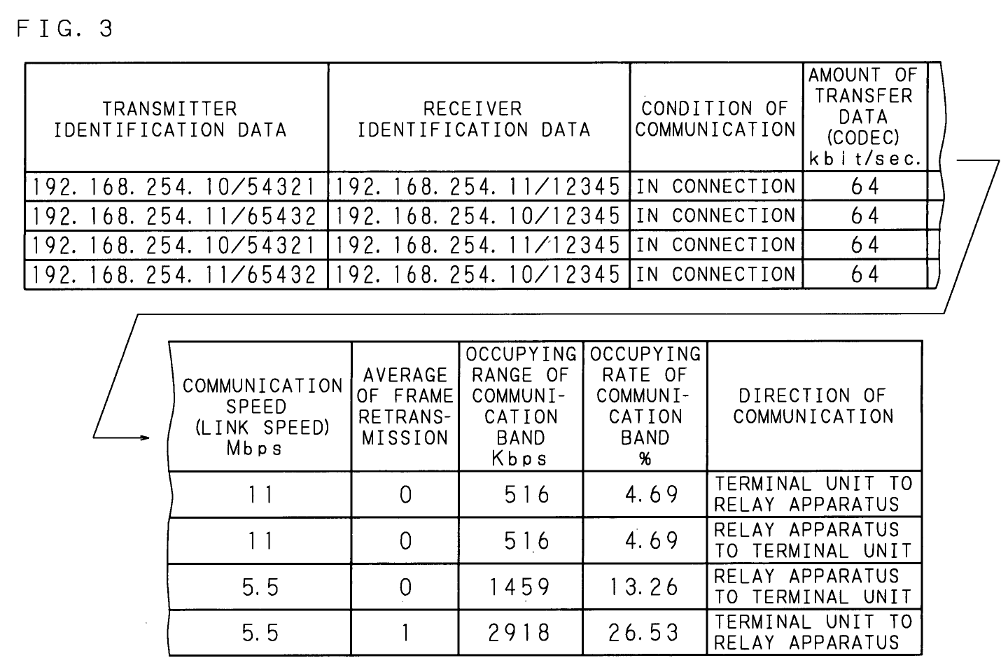

FIG. 3 is an explanatory view schematically showing an example of the management table 12a saved in the relay apparatus 1 of the present invention. The management table 12a indicates a list of records for communications at priority, e.g., in the streaming service of the relay apparatus 1. More particularly, the list of records in the management table 12a may include identification data for identifying the terminal units 2 as the transmitter and the receiver, data about the condition of the communication, the amount of data to be transferred, the communication speed (the link speed), the average of the retransmission of frames, the communication bandwidth being used, the rate of occupying the communication bandwidth, and the direction of the communication which correspond to each other. In the management table 12a of FIG. 3, the first terminal unit 2 denoted by an IP address of 192.168.254.10 is assigned with the receiving port 12345 and the transmitting port 54321 for communication with the relay apparatus 1 at a communication speed of 11 Mbps while the second terminal unit 2 denoted by an IP address of 192.168.254.11 is assigned with the receiving port 12345 and the transmitting port 65432 for communication with the relay apparatus 1 at a communication speed of 5.5 Mbps. Simultaneously, the relay apparatus 1 permits the communications between the first terminal unit 2 and the second terminal unit 2. The list of records in the management table 12a is updated in a succession.

The IP address of 193.168.254.10 and the port number 54321 of the first terminal unit 2 represent the identification data of the transmitter terminal 2 while the IP address of 193.168.254.11 and the port number 65432 of the second terminal unit 2 represent the identification data of the receiver terminal 2.

The data about the condition of communication indicates the condition of communication such as “busy line”. The amount of data to be transferred represents a data size needed for the streaming service (for example, at 64 kbit/s). The communication speed is a link speed between the relay apparatus 1 and the terminal unit 2 which is selected from 11 Mbps, 5.5 Mbps, 2 Mbps, and 1 Mbps in the IEEE 802.11b wireless communication standard. The average of the retransmission of frames is an average of the number of times between, for example, the latest ten communication frames for transmission of communication frames one by one.

The occupying range of the communication bandwidth is a size of bandwidth required for transmission of the amount of data from each terminal unit at the rate of exchangeable data per unit time (the communication bandwidth) provided by the relay apparatus 1. In the management table 12a of FIG. 3, the occupying range of the communication bandwidth is expressed in Kbps as calculated from Equation 1 shown below. The rate of occupying the communication bandwidth is hence a percentage (%) of the bandwidth being used in the available communication bandwidth. It would be understood that the rate of occupying the communication bandwidth is expressed by a length of time (msec) in a period or a percentage (%) of time.
The occupying bandwidth={amount of data×(11/communication speed)+(occupying bandwidth in waiting period+header size×(11/communication speed)+occupying bandwidth at ACK)×number of frames per second}×(average of frame retransmission+1) Equation 1

The direction of the communication is either from the terminal unit to the relay apparatus or from the relay apparatus to the terminal unit.

The action of each component in the communications system of the present invention will now be described. In brief, the communications system of the present invention saves a particular range of the communication bandwidth to be assigned to the streaming service in the wireless LAN of the relay apparatus 1 and determines the communication speed so that the communication bandwidth being used as the streaming service is not greater than the particular range of the communication bandwidth to be assigned to the streaming service. More particularly, the procedure is as follows.

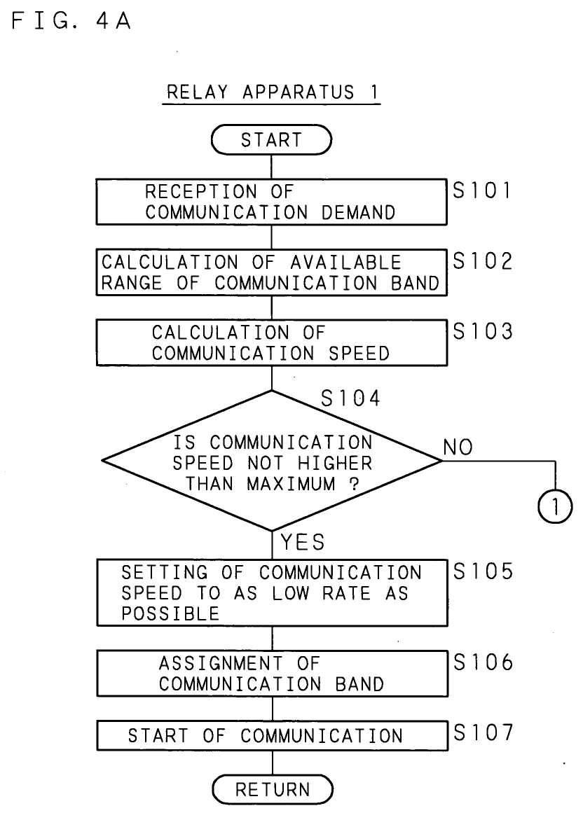

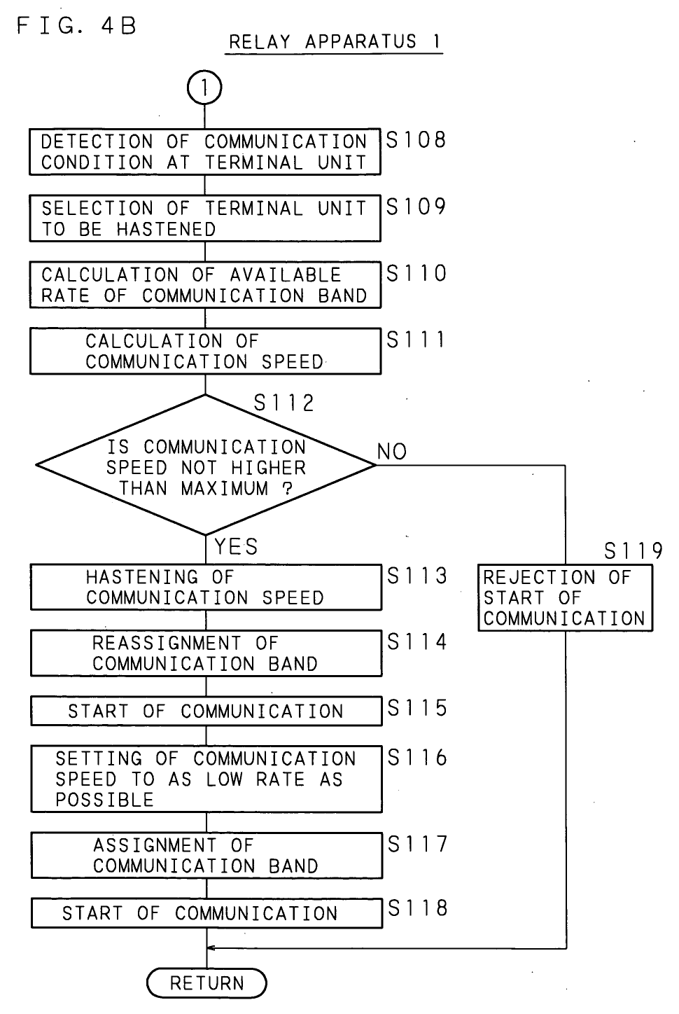

FIGS. 4A and 4B are flowcharts showing an action of the relay apparatus 1 in the communications system of the present invention for starting a new communication. The action starts with the relay apparatus 1 commands the controlling unit 10 to carry out the computer program 200 saved in the temporal storage unit 13 and permits the wireless communicating unit 14 to receive a demand of connection at the streaming service from a terminal unit 2 which wants to start a communication (S101). Using the list of records in the management table 12a, an available range of the communication bandwidth assigned to the streaming service is determined (S102). This is followed by calculating the communication speed for transmission of data of a given size or namely 64 kbit/s in this embodiment within the determined communication bandwidth (S103). It is then examined whether the calculated communication speed is not higher than its maximum level or namely 11 Mbps in this embodiment (S104). The steps S102 to S104 are provided for obtaining an available range of the communication bandwidth assigned to the terminal unit 2 which wants to start a communication. The terminal unit 2 which wants to start a communication will be referred to as a transmitter terminal unit 2a for ease of the description.

When it is judged at Step S104 that the communication speed determined at Step S103 is not higher than its maximum level and the available range of the communication bandwidth is thus obtained for the transmitter terminal unit 2a starting the communication (yes at S104), the relay apparatus 1 commands the controlling unit 10 to assign the transmitter terminal unit 2 with as a low rate of the communication speed as possible through the available communication bandwidth (S105) and with a particular range of the communication bandwidth corresponding to the low communication speed (S106). Then, the communication is commenced at the low communication speed over the determined range of the communication bandwidth (S107). Both the low communication speed and the determined range of the communication bandwidth are recorded in the management table 12a.

When it is judged at Step S104 that the communication speed determined at Step S103 is higher than its maximum level and the available range of the communication bandwidth is not obtained for transmitter terminal unit 2a (no at S104), the relay apparatus 1 commands the controlling unit 10 to detect the condition of communication between the two terminal units 2 (S108) and select the terminal unit 2 over the condition of the communication for increasing the communication speed (S109). The selection over the condition of the communication involves selecting the terminal unit 2 of which the condition of the communication is higher through examining the frame retransmission rate, the communication speed, and the strength of communication signals in relation to the terminal units 2 being connected. More particularly, the terminal unit 2 which is the lowest in the frame retransmission rate is selected at the first priority. When two or more of the terminal units 2 which are the lowest in the frame retransmission rate are found, their lowest in the communication speed is chosen. When two or more of the terminal units 2 which are the lowest in the communication speed are present, their highest in the strength of communication signals is chosen. The condition of the communication is examined in order of priority from the frame retransmission rate to the communication speed and the strength of communication signals. Two or more of the terminal units 2 may be selected for increasing the communication speed. The terminal unit 2 of which the communication speed is increased will be referred to as a selected terminal unit 2b for ease of the description.

This is followed by the relay apparatus 1 commanding the controlling unit 10 to determine an available range (which has not been occupied) of the communication bandwidth at the higher rate of the communication speed of the selected terminal unit 2b (S110), calculate the communication speed for the transmitter terminal unit 2a carrying out the streaming service to transmit a desired amount of data within the available rage of the communication bandwidth (S111), and examine whether the calculated communication speed is not higher than its maximum level (S112). The steps S110 to S112 are provided for examining whether the communication bandwidth is obtained or not for the transmitter terminal unit 2a which wants to start a communication.

When it is judged at Step 112 that the communication speed determined at Step S111 is not higher than its maximum level and the communication bandwidth required for the transmitter terminal unit 2a starting the communication is obtained (yes at S112), the relay apparatus 1 commands the controlling unit 10 to increase the communication speed of the selected terminal unit 2 (S113), assign again the terminal unit 2 with another range of the communication bandwidth corresponding to the increased communication speed (S114), and start the communication at the higher speed over the newly assigned communication bandwidth (S115). As both the communication speed and the communication bandwidth are modified, the communication bandwidth assigned to the transmitter terminal unit 2a can be optimized. In succession, the relay apparatus 1 commands the controlling unit 10 to assign the transmitter terminal unit 2a with as a low rate of the communication speed as possible through the increased communication bandwidth (S116) and with a particular range of the communication bandwidth corresponding to the low communication speed (S117). Then, the communication is commenced at the low communication speed over the determined range of the communication bandwidth (S118). Both the low communication speed and the determined range of the communication bandwidth are recorded in the management table 12a.

When it is judged at Step S112 that the communication speed determined at Step S111 is higher than its maximum level and the available range of the communication bandwidth is not obtained for the transmitter terminal unit 2a starting the communication (no at S112), the relay apparatus 1 commands the controlling unit 10 to deliver from the wireless communicating unit 14 to the transmitter terminal unit 2a a signal indicating that its location is out of the communicable area and reject the start of the communication, or the relay apparatus 1 commands the controlling unit 10 to deliver from the wire communicating unit 15 to the communication management center 3 identification data for identifying the transmitter terminal unit 2a and a signal indicating that its location is out of the communicable area and reject the start of the communication (S119). Even if Step S112 has judged that the communication bandwidth is obtained, the start of the communication will be rejected when the condition of communication with the transmitter terminal unit 2a remains unstable.

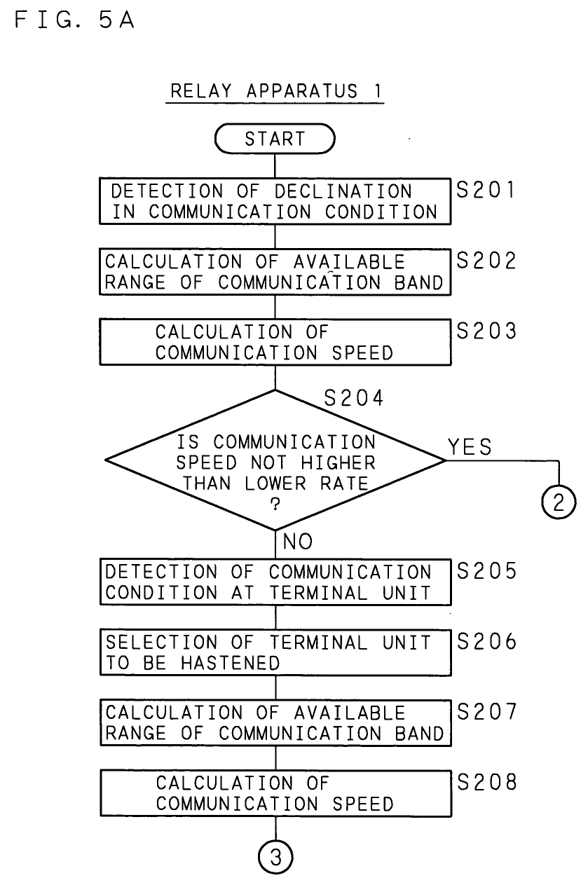

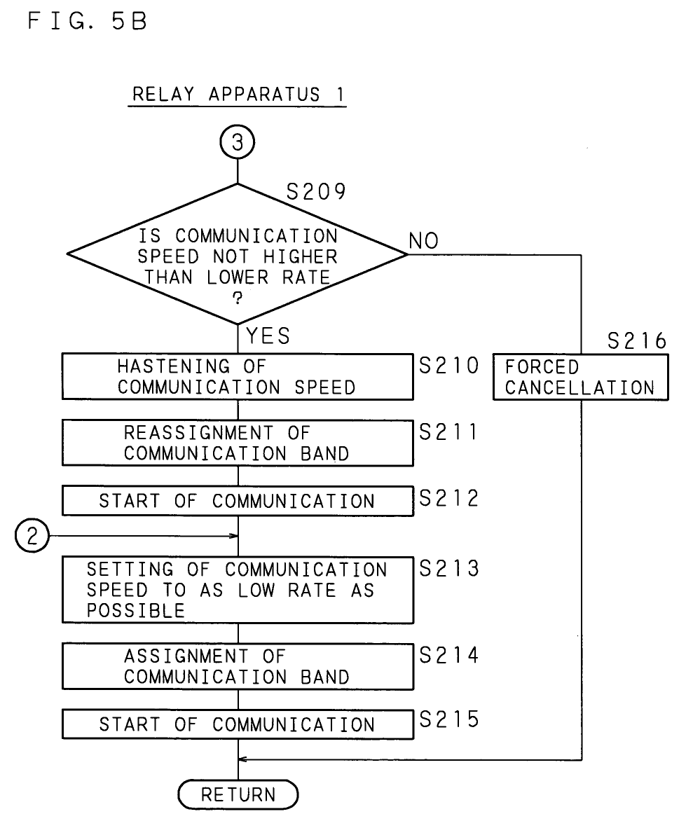

FIGS. 5A and 5B are flowcharts showing an action of the relay apparatus 1 in the communications system of the present invention for improving the condition of communication. The action starts with the relay apparatus 1 commanding the controlling unit 10 to carry out the computer program 200 saved in the temporal storage unit 13 and acknowledge that the terminal unit 2 connected to the wireless communicating unit 14 is unfavorable in the condition of communication (S201). This is followed by determining an available range of the communication bandwidth assigned to the streaming service referring to the list of records in the management table 12a (S202). The detection of the unfavorable condition of communication with the terminal apparatus 2 at Step S201 is based on the frame retransmission rate and the strength of communication signals recorded in the management table 12a. When the frame retransmission rate exceeds its upper limit level or abruptly deteriorates or when the strength of communication signals drops down to its lower limit level or abruptly deteriorates, it is judged that the condition of communication is turned unstable. The terminal unit 2 of which the condition of communication is turned unstable will be referred to as an unstable terminal unit 2c for ease of the description.

The relay apparatus 1 of the present invention commands the controlling unit 10 to determine the communication speed for the unstable terminal unit 2c conducting the streaming service to transmit a desired amount of data within the determined available range of the communication bandwidth (S203). It is then examined whether the communication speed determined at S203 is not higher than a low rate of the communication speed of the unstable terminal unit 2c (S204).

When it is judged at Step S204 that the communication speed determined at Step S203 is higher than the low rate of the communication speed (no at S204), the relay apparatus 1 commands the controlling unit 10 to detect the condition of communication of each of the terminal units 2 being connected (S205) and select the terminal unit 2 to be increased in the communication speed through examining the condition of communication (S206). The terminal unit 2 selected will be referred to as a selected terminal unit 2d for ease of the description.

This is followed by the relay apparatus 1 commanding the controlling unit 10 to determine an available range (which has not been occupied) of the communication bandwidth at the higher rate of the communication speed of the selected terminal unit 2d (S207) and calculate the communication speed for the unstable terminal unit 2c carrying out the streaming service to transmit a desired amount of data within the available range of the communication bandwidth (S208). It is then examined whether or not the communication speed calculated at S208 is not higher than the low communication speed of the unstable terminal unit 2c (S209).

When it is judged at Step 209 that the communication speed determined at Step S208 is not higher than the low communication speed (yes at S209), the relay apparatus 1 commands the controlling unit 10 to increase the communication speed of the selected terminal unit 2d (S210), assign again the terminal unit 2d with another range of the communication bandwidth corresponding to the increased communication speed (S211), and start the communication at the higher speed over the newly assigned communication bandwidth (S212). In succession, the relay apparatus 1 commands the controlling unit 10 to assign the unstable terminal unit 2d with as a low rate of the communication speed as possible through the increased communication bandwidth (S213) and with a particular range of the communication bandwidth corresponding to the low communication speed (S214). Then, the communication is commenced at the low communication speed over the determined range of the communication bandwidth (S215). Both the determined range of the communication bandwidth and the low communication speed are recorded in the management table 12a.

When it is judged at Step S204 that the communication speed determined at Step S203 is not higher than the low rate of the communication speed (yes at S204), the action jumps to Step S213 before carrying out the following steps.

When it is judged at Step S209 that the communication speed determined at Step S208 is higher than the low rate of the communication speed (no at S209), the relay apparatus 1 commands the controlling unit 10 to deliver from the wireless communicating unit 14 to the unstable terminal unit 2c a signal indicating that its location is out of the communicable area and forcibly disconnect the communication, or the relay apparatus 1 commands the controlling unit 10 to deliver from the wire communicating unit 15 to the communication management center 3 identification data for identifying the transmitter terminal unit 2a and a signal indicating that its location is out of the communicable area and reject the start of the communication (S216). With the communication speed of the unstable terminal unit 2c being decreased, the condition of communication is regarded as unstable at Step S201 when it is so. Also, when the terminal unit 2 of which the communication speed has been increased by the action of newly starting a communication shown in the flowchart of FIGS. 4A and 4B or by the action of improving the condition of communication is declined in the condition of communication, its declination in the communication condition can equally be detected at Step 201. However, during the foregoing action of steps, the communication bandwidth for the streaming service may temporarily be unavailable due to busy connections. For compensation, a communication bandwidth for data transmission at lower priority can be temporarily used or an auxiliary communication bandwidth can be determined and saved in advance.

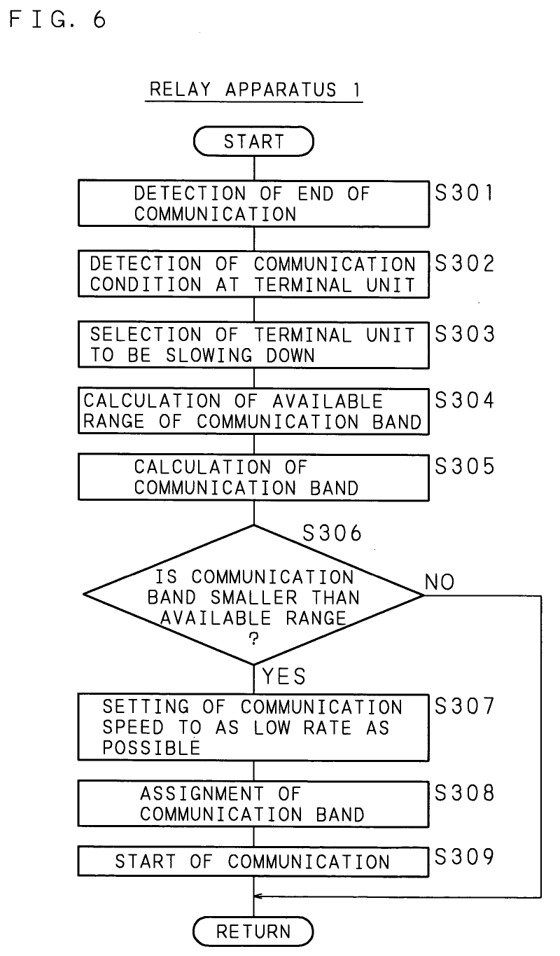

FIG. 6 is a flowchart showing an action of the relay apparatus 1 in the communications system of the present invention for decreasing the communication speed. The action starts with the relay apparatus 1 commanding the controlling unit 10 to carry out the computer program 200 saved in the temporal storage unit 13 and acknowledge that the terminal unit 2 connected to the wireless communicating unit 14 terminates its communication (S301). This is followed by detecting the condition of communication between the terminal units 2 (S302) and selecting the terminal unit 2 to be decreased in the communication speed referring to the condition of communication detected (S303). The selection over the condition of the communication involves selecting the terminal unit 2 of which the condition of the communication is most unfavorable through examining the frame retransmission rate, the communication speed, and the strength of communication signals in relation to the terminal units being connected. More particularly, the terminal unit 2 which is the highest in the frame retransmission rate is selected as the terminal unit 2 of which the condition of the communication is most unfavorable at the first priority. When two or more of the terminal units 2 which are the highest in the frame retransmission rate are found, their highest in the communication speed is chosen as the terminal unit 2 of which the condition of the communication is most unfavorable. When two or more of the terminal units 2 which are the highest in the communication speed are present, their lowest in the strength of communication signals is chosen as the terminal unit 2 of which the condition of the communication is most unfavorable. The condition of the communication is examined in order of priority from the frame retransmission rate to the communication speed and the strength of communication signals. The selected terminal unit 2 of which the communication speed is decreased will be referred to as a selected terminal unit 2e for ease of the description.

This is followed by the relay apparatus 1 commanding the controlling unit 10 to determine an available range (which has not been occupied) of the communication bandwidth which is enlarged at the end of the communication of the terminal unit 2 (S304) and calculate a range of the communication bandwidth for transmission of a desired amount of data in the streaming service when the communication speed of the selected terminal unit 2e has been decreased within the available range of the communication bandwidth (S305). It is then judged whether or not the communication bandwidth calculated is not greater than the available range (S306).

When it is judged at Step S306 that the communication bandwidth calculated at Step S305 is not greater than the available range (yes at S306), the relay apparatus 1 commands the controlling unit 10 to decrease the communication speed of the selected terminal unit 2e to as a low rate as possible (S307) and assign again the terminal unit 2e with a particular range of the communication bandwidth corresponding to the low rate of the communication speed (S308). Then, the communication is commenced at the low communication speed over the determined range of the communication bandwidth (S309). Both the determined range of the communication bandwidth and the low communication speed are recorded in the management table 12a.

When it is judged at Step S306 that the communication bandwidth calculated at Step S305 is greater than the available range (no at S306), the step of decreasing the communication speed is not carried out but the flowchart is terminated.

The present invention is not limited to the embodiments where the communication speed is set to as a low rate as possible depending on the condition of communication but may allow the communication speed to be arbitrarily determined for improving the stability of the communications. More specifically, the communication speed can be determined from an average of the communication speeds of all the terminal units which are being connected at the time. When a greater number of the terminal units are involved for communications thus to produce a shortage of the communication bandwidths, the average of the communication speeds will be increased. When a less number of the terminal units are being connected to permit an abundance of the communication bandwidths, the average of the communication speeds will drop down. According to the present invention, the communication speed at the start of another communication is determined from an average of the communication speeds calculated at the end of the preceding communication. Hence, the determined communication speed can be hastened when an available range of the communication bandwidth is small due to a greater number of the terminal units being connected at the time. Alternatively, the determined communication speed can be slowed down when an available range of the communication bandwidth is abundant due to a less number of the terminal units being connected at the time. This allows the communication speed of each terminal unit to be increased at less frequency even when a new communication is started or the existing communication is declined in the condition than the case that the communication speed is set to as a low rage as possible. As a result, the communication can remain much stable.

Also, the present invention is not limited to the application of IP telephones in the VoIP technology but may be applied with equal success to any wireless communications where a desired amount or more of data has to be transmitted smoothly.

As this invention may be embodied in several forms without departing from the spirit of essential characteristics thereof, the present embodiment is therefore illustrative and not restrictive, since the scope of the present invention is defined by the appended claims rather than by the description preceding them, and all changes that fall within metes and bounds of the claims, or equivalence of such metes and bounds thereof are therefore intended to be embraced by the claims.

1. A communications method, being used in a group of terminal units and a relay apparatus which conducts wireless communications with the terminal units, comprising steps of:
assigning each terminal unit with an available range of a communication bandwidth which is not occupied;
sending and receiving data with the terminal unit over the available range of the communication bandwidth at a communication speed predetermined for the terminal unit; and
modifying the communication speed of the terminal unit in response to the occupied state of the communication bandwidth.

2. A communications method, being used in a group of terminal units and a relay apparatus which conducts wireless communications with the terminal units, comprising steps of:
assigning each terminal unit with an available range of a communication bandwidth which is not occupied;
sending and receiving data with the terminal unit over the available range of the communication bandwidth at a communication speed predetermined for the terminal unit;
calculating a favorable range of the communication bandwidth from the occupied state of the communication bandwidth; and
modifying the communication speed to the lowest rate over the favorable range of the communication bandwidth.

3. A communications system having a group of terminal units and a relay apparatus which conducts wireless communications with the terminal units, the relay apparatus comprising:
means for assigning each of the terminal units with an available range of the communication bandwidth which is not occupied;
means for sending and receiving data with the terminal unit over the available range of the communication bandwidth at a communication speed predetermined for the terminal unit; and
means for modifying the communication speed of the terminal unit in response to the occupied state of the communication bandwidth.

4. A communications system having a group of terminal units and a relay apparatus which conducts wireless communications with the terminal units, the relay apparatus comprising:
means for assigning each of the terminal units with an available range of the communication bandwidth which is not occupied;
means for sending and receiving data with the terminal unit over the available range of the communication bandwidth at a communication speed predetermined for the terminal unit; and
means for modifying the communication speed to as a low rate as possible in response to the occupied state of the communication bandwidth.

5. A relay apparatus comprising:
means for conducting wireless communications with a group of terminal units;
means for assigning each of the terminal units with an available range of the communication bandwidth which is not occupied;
means for sending and receiving data with the terminal unit over the available range of the communication bandwidth at a communication speed predetermined for the terminal unit;
means for recording the occupied state of the communication bandwidth; and
means for modifying the communication speed of the terminal unit in response to the recorded occupied state of the communication bandwidth.

6. A relay apparatus according to claim 5, further comprising:
means for detecting a change in the number of the terminal units being connected or a change in the condition of communication at the terminal unit; and
means for modifying the communication speed of each of the terminal unit or assigning again the terminal unit with a favorable range of the communication bandwidth in response to the change.

7. A relay apparatus according to claim 5, further comprising:
means for receiving a demand for starting a communication from one of the terminal units which is not connected, wherein
the means for modifying the communication speed determines the communication speed for communication with the one of the terminal units which demands the start of communication.

8. A relay apparatus according to claim 5, further comprising:
means for examining from the available range of the communication bandwidth determined by the calculating means whether a desired range of the communication bandwidth is available or not for communication with the one of the terminal units which demands the start of communication;
means for, when it is judged that the desired range of the communication bandwidth is not available, detecting the condition of communication with the terminal units being connected;
means for selecting the terminal unit of which the communication speed is to be increased through reviewing the detected condition of communication; and
means for increasing the communication speed of the selected terminal unit.

9. A relay apparatus according to claim 5, further comprising:
means for measuring a declination in the condition of communication at the terminal unit being connected;
means for detecting the condition of communication with the other terminal units;
means for selecting the terminal unit of which the communication speed is to be increased through reviewing the detected condition of communication;
means for increasing the communication speed of the selected terminal unit;
means for assigning again the terminal unit of which the condition of communication is declined with a favorable range of the communication bandwidth; and
means for decreasing the communication speed of the terminal unit of which the condition of communication is declined.

10. A relay apparatus according to claim 5, wherein
the data sent and received with the terminal units is data for the streaming service which has to be transmitted at a predetermined speed.

11. A relay apparatus according to claim 5, wherein
a table is provided in which the rate of occupying the communication bandwidth, the communication speed, and the amount of data to be transmitted are recorded in relation to the terminal unit as a receiver.

12. A relay apparatus comprising:
means for conducting wireless communications with a group of terminal units;
means for assigning each of the terminal units with an available range of the communication bandwidth which is not occupied;
means for sending and receiving data with the terminal unit over the available range of the communication bandwidth at a communication speed predetermined for the terminal unit;
means for recording the occupied state of the communication bandwidth;
means for calculating a favorable range of the communication bandwidth in response to the recorded occupied state of the communication bandwidth; and
means for modifying the communication speed of the terminal unit to as a low rate as possible over the favorable range of the communication bandwidth.

13. A relay apparatus according to claim 12, further comprising:
means for detecting a change in the number of the terminal units being connected or a change in the condition of communication at the terminal unit; and
means for modifying the communication speed of each of the terminal unit or assigning again the terminal unit with a favorable range of the communication bandwidth in response to the change.

14. A relay apparatus according to claim 12, further comprising:
means for receiving a demand for starting a communication from one of the terminal units which is not connected, wherein
the means for modifying the communication speed determines the communication speed for communication with the one of the terminal units which demands the start of communication.

15. A relay apparatus according to claim 12, further comprising:
means for examining from the available range of the communication bandwidth determined by the calculating means whether a desired range of the communication bandwidth is available or not for communication with the one of the terminal units which demands the start of communication;
means for, when it is judged that the desired range of the communication bandwidth is not available, detecting the condition of communication with the terminal units being connected;
means for selecting the terminal unit of which the communication speed is to be increased through reviewing the detected condition of communication; and
means for increasing the communication speed of the selected terminal unit.

16. A relay apparatus according to claim 12, further comprising:
means for measuring a declination in the condition of communication at the terminal unit being connected;
means for detecting the condition of communication with the other terminal units;
means for selecting the terminal unit of which the communication speed is to be increased through reviewing the detected condition of communication;
means for increasing the communication speed of the selected terminal unit;
means for assigning again the terminal unit of which the condition of communication is declined with a favorable range of the communication bandwidth; and
means for decreasing the communication speed of the terminal unit of which the condition of communication is declined.

17. A relay apparatus according to claim 12, wherein
the data sent and received with the terminal units is data for the streaming service which has to be transmitted at a predetermined speed.

18. A relay apparatus according to claim 12, wherein
a table is provided in which the rate of occupying the communication bandwidth, the communication speed, and the amount of data to be transmitted are recorded in relation to the terminal unit as a receiver.

19. A relay apparatus comprising a processor capable of: performing the operations of
conducting wireless communications with a group of terminal units;
assigning each of the terminal units with an available range of the communication bandwidth which is not occupied;
sending and receiving data with the terminal unit over the available range of the communication bandwidth at a communication speed predetermined for the terminal unit;
recording the occupied state of the communication bandwidth; and
modifying the communication speed of the terminal unit in response to the recorded occupied state of the communication bandwidth.

20. A relay apparatus according to claim 19, wherein the processor is further capable of performing the operations of:
detecting a change in the number of the terminal units being connected or a change in the condition of communication at the terminal unit; and
modifying the communication speed of each of the terminal unit or assigning again the terminal unit with a favorable range of the communication bandwidth in response to the change.

21. A relay apparatus according to claim 19, wherein the processor is further capable of performing the operations of receiving a demand for starting a communication from one of:
the terminal units which is not connected, and
modifying the communication speed for communication with the one of the terminal units which demands the start of communication.

22. A relay apparatus according to claim 19, wherein the processor is further capable of performing the operations of:
examining from the available range of the communication bandwidth determined whether a desired range of the communication bandwidth is available or not for communication with the one of the terminal units which demands the start of communication;
when it is judged that the desired range of the communication bandwidth is not available, detecting the condition of communication with the terminal units being connected;
selecting the terminal unit of which the communication speed is to be increased through reviewing the detected condition of communication; and
increasing the communication speed of the selected terminal unit.

23. A relay apparatus according to claim 19, wherein the processor is further capable of performing the operations of:
measuring a declination in the condition of communication at the terminal unit being connected;
detecting the condition of communication with the other terminal units;
selecting the terminal unit of which the communication speed is to be increased through reviewing the detected condition of communication;
increasing the communication speed of the selected terminal unit;
assigning again the terminal unit of which the condition of communication is declined with a favorable range of the communication bandwidth; and
decreasing the communication speed of the terminal unit of which the condition of communication is declined.

24. A relay apparatus according to claim 19, wherein
the data sent and received with the terminal units is data for the streaming service which has to be transmitted at a predetermined speed.

25. A relay apparatus according to claim 19, wherein
a table is provided in which the rate of occupying the communication bandwidth, the communication speed, and the amount of data to be transmitted are recorded in relation to the terminal unit as a receiver.

26. A relay apparatus comprising a processor capable of performing the operations of:
conducting wireless communications with a group of terminal units;
assigning each of the terminal units with an available range of the communication bandwidth which is not occupied;
sending and receiving data with the terminal unit over the available range of the communication bandwidth at a communication speed predetermined for the terminal unit;
recording the occupied state of the communication bandwidth;
calculating a favorable range of the communication bandwidth in response to the recorded occupied state of the communication bandwidth; and
modifying the communication speed of the terminal unit to the lowest rate over the favorable range of the communication bandwidth.

27. A relay apparatus according to claim 26, wherein the processor is further capable of performing the operations of:
detecting a change in the number of the terminal units being connected or a change in the condition of communication at the terminal unit; and
modifying the communication speed of each of the terminal unit or assigning again the terminal unit with a favorable range of the communication bandwidth in response to the change.

28. A relay apparatus according to claim 26, wherein the processor is further capable of performing the operations of:
receiving a demand for starting a communication from one of the terminal units which is not connected, wherein
modifying the communication speed for communication with the one of the terminal units which demands the start of communication.

29. A relay apparatus according to claim 26, wherein the processor is further capable of performing the operations of:
examining from the available range of the communication bandwidth determined whether a desired range of the communication bandwidth is available or not for communication with the one of the terminal units which demands the start of communication;
when it is judged that the desired range of the communication bandwidth is not available, detecting the condition of communication with the terminal units being connected;
selecting the terminal unit of which the communication speed is to be increased through reviewing the detected condition of communication; and
increasing the communication speed of the selected terminal unit.

30. A relay apparatus according to claim 26, wherein the processor is further capable of performing the operations of:
measuring a declination in the condition of communication at the terminal unit being connected;
detecting the condition of communication with the other terminal units;
selecting the terminal unit of which the communication speed is to be increased through reviewing the detected condition of communication;
increasing the communication speed of the selected terminal unit;
assigning again the terminal unit of which the condition of communication is declined with a favorable range of the communication bandwidth; and
decreasing the communication speed of the terminal unit of which the condition of communication is declined.

31. A relay apparatus according to claim 26, wherein
the data sent and received with the terminal units is data for the streaming service which has to be transmitted at a predetermined speed.

32. A relay apparatus according to claim 26, wherein
a table is provided in which the rate of occupying the communication bandwidth, the communication speed, and the amount of data to be transmitted are recorded in relation to the terminal unit as a receiver.

33. A recording medium in which a computer program for a computer is stored for conducting wireless communications with a group of terminal units, assigning each of the terminal units with an available range of the communication bandwidth which is not occupied, and sending and receiving data with the terminal unit over the available range of the communication bandwidth at a communication speed predetermined for the terminal unit, wherein
the computer program stored in the recording medium comprises the step of causing the computer to modify the communication speed of the terminal unit in response to the occupied state of the communication bandwidth.

34. A recording medium in which a computer program for a computer is stored for conducting wireless communications with a group of terminal units, assigning each of the terminal units with an available range of the communication bandwidth which is not occupied, and sending and receiving data with the terminal unit over the available range of the communication bandwidth at a communication speed predetermined for the terminal unit, wherein
the computer program stored in the recording medium comprises the steps of:
causing the computer to calculate a favorable range of the communication bandwidth from the occupied state of the communication bandwidth; and
causing the computer to modify the communication speed of the terminal unit to as a low rate as possible over the favorable range of the communication bandwidth.
